(19) United States
(12) Patent Application Publication
(10) Pub. No.: US 2016/0113837 A1
(43) Pub. Date: Apr. 28, 2016

(54) PHYSICAL THERAPY DEVICE

(71) Applicant: Scott Kenneth BURSON, Seal Beach, CA (US)

(72) Inventor: Scott Kenneth BURSON, Seal Beach, CA (US)

(21) Appl. No.: 14/920,083

(22) Filed: Oct. 22, 2015

Related U.S. Application Data
(60) Provisional application No. 62/067,576, filed on Oct. 23, 2014.

(51) Int. Cl. A61H 15/00

(52) U.S. Cl. CPC A61H 15/0092; A61H 2015/0035; A61H 2015/005

(57) ABSTRACT

A physical therapy device includes an axle member having first and second distal ends, a first wheel of a first diameter disposed about the axle member, a second wheel of the first diameter disposed about the axle member, a first rounded end cap massager disposed at least partially over the first distal end of the axle member, the first rounded end cap massager having a second diameter that is less than the first diameter, and a second rounded end cap massager disposed at least partially over the second distal end of the axle member.

### RELATED APPLICATION

This application claims priority to U.S. Provisional Application No. 62/067,576, filed on Oct. 23, 2014, entitled PHYSICAL THERAPY DEVICE, the disclosure of which is hereby incorporated by reference in its entirety.

### BACKGROUND

1. Field

The present disclosure generally relates to physical therapy devices.

2. Description of Related Art

Physical therapy devices designed for use in massaging, stretching and/or applying pressure to human tissue and the like may have various configurations and/or features. Some physical therapy devices can be somewhat cumbersome and/or ineffective in use.

### SUMMARY

In some implementations, the present disclosure relates to a physical therapy device including an axle member having first and second distal ends and a first wheel of a first diameter disposed about the axle member, and a second wheel of the first diameter disposed about the axle member. The physical therapy device further includes a first rounded end cap massager disposed at least partially over the first distal end of the axle member, the first rounded end cap massager having a second diameter that is less than the first diameter, and a second rounded end cap massager disposed at least partially over the second distal end of the axle member.

Rotation of at least one of the first and second rounded end cap massagers may reduce an axial distance between the first and second wheels. In certain embodiments, the axle member includes a male threaded distal end and the first rounded end cap includes a female threaded recess configured to receive the threaded distal end of the axle member.

The physical therapy device may further include a resistance member disposed about the axle member between the first and second wheels and configured to provide outward force against the first and second wheels in an axial direction. The resistance member may be a one-piece bellows form configured to provide relatively superficial skin massage functionality.

In certain embodiments, a massaging surface of the first and second wheels includes a first material and a massaging surface of the first and second rounded end cap massagers include a second material, wherein the second material is more rigid than the first material. The first and second rounded end cap massagers may be at least partially spherical in shape. In certain embodiments, the first and second wheels have at least partially flat massaging contact surfaces. The massaging contact surface of each of the first and second wheels may include an axial apex portion.

In some implementations, the present disclosure relates to a physical therapy device including a first rounded massaging form of a first diameter disposed at a first distal end of the physical therapy device and a second rounded massaging form of the first diameter disposed at a second distal end of the physical therapy device. The physical therapy device further includes a first wheel massager of a second diameter disposed adjacent to the first rounded massaging form between the first and second rounded massaging forms with respect to a longitudinal axis of the physical therapy device, the second diameter being greater than the first diameter, and a second wheel massager disposed adjacent to the second rounded massaging form between the second rounded massaging form and the first wheel massager with respect to the longitudinal axis. The physical therapy device further includes a central skin-massaging form having a third diameter disposed between the first wheel massager and the second wheel massager with respect to the longitudinal axis, the third diameter being smaller than the second diameter. In certain embodiments, the first and second rounded massaging forms, the first and second wheel massagers, and the central rounded massager are coaxial about the longitudinal axis.

Rotation of at least one of the first and second rounded massaging forms may reduce an axial distance between the first and second wheel massagers. In certain embodiments, the third diameter is smaller than the first diameter. In certain embodiments, the massaging surface of the first and second wheel massagers may include a first material, the massaging surface of the first and second rounded massing forms includes a second material, and the massaging surface of the central skin-massaging form includes a third material, wherein the first material is less rigid than the second material and more rigid than the third material.

The first and second rounded massaging forms may be at least partially spherical in shape. In certain embodiments, the first rounded massaging form is configured such that rotation of the first rounded massaging form relative to the second rounded massaging form causes the first and second wheel massagers to be brought closer together.

In some implementations, the present disclosure relates to a process of massaging tissue. The process involves providing a physical therapy device involving an axle member having first and second distal ends, a first wheel of a first diameter disposed about the axle member, a second wheel of the first diameter disposed about the axle member, a first rounded end cap massager disposed at least partially over the first distal end of the axle member, the first rounded end cap massager having a second diameter that is less than the first diameter, and a second rounded end cap massager disposed at least partially over the second distal end of the axle member. The process further involves adjusting an axial distance between the first and second wheels to a desired distance, positioning the physical therapy device in contact with a target body area, applying body weight against the physical therapy device at the target body area, and removing body weight from the physical therapy device.

The process may further involve rotating at least one of the first and second rounded end cap massagers to reduce an axial distance between the first and second wheels. In certain embodiments, the axle member includes a male threaded distal end and the first rounded end cap includes a female threaded recess configured to receive the threaded distal end of the axle member. The physical therapy device may further include a resistance member disposed about the axle member between the first and second wheels and configured to provide outward force against the first and second wheels in an axial direction. In certain embodiments, the resistance member is a one-piece bellows form. The process may further involve massaging target skin using the resistance member.

### BRIEF DESCRIPTION OF THE DRAWINGS

Various embodiments are depicted in the accompanying drawings for illustrative purposes, and should in no way be interpreted as limiting the scope of the inventions. In addition, various features of different disclosed embodiments can be combined to form additional embodiments, which are part of this disclosure. Throughout the drawings, reference numbers may be reused to indicate correspondence between reference elements.

FIG. 1 is a perspective view of a physical therapy device according to one or more embodiments.

FIG. 2 represents a front, back, top and/or bottom view of the physical therapy device of FIG. 1 according to one or more embodiments.

FIG. 3 represents a front, back, top and/or bottom view of the physical therapy device of FIG. 1 according to one or more embodiments.

FIG. 4 represents a cross-sectional front, back, top and/or bottom view of the physical therapy device of FIG. 1 according to one or more embodiments.

FIG. 5 represents an exploded front, back, top and/or bottom view of the physical therapy device of FIG. 1 according to one or more embodiments.

FIG. 6 is a side view of the physical therapy device of FIG. 1 according to one or more embodiments.

FIGS. 7A-7C are side views of physical therapy devices according to various embodiments.

FIG. 8 represents a perspective view of a physical therapy device according to one or more embodiments.

FIG. 9 illustrates a user using a physical therapy device according to one or more embodiments.

FIG. 10 is a flow diagram illustrating a process for using a physical therapy device according to one or more embodiments.

FIG. 11 is a flow diagram illustrating a process for using a physical therapy device according to one or more embodiments.

### DETAILED DESCRIPTION

While certain embodiments are described, these embodiments are presented by way of example only, and are not intended to limit the scope of protection. Indeed, the novel methods and systems described herein may be embodied in a variety of other forms. Furthermore, various omissions, substitutions and changes in the form of the methods and systems described herein may be made without departing from the scope of protection.

The headings provided herein are for convenience only and do not necessarily affect the scope or meaning of the claimed invention. Disclosed herein are example configurations and embodiments relating to physical therapy devices generally, as well as methods for performing physical therapy using wheeled physical therapy devices.

### Physical Therapy Devices

Certain embodiments disclosed herein relate at least in part to physical and/or massage therapy devices and/or methods. For example, certain embodiments provide a portable, therapeutic rolling device which may be utilized for self-spinal manipulation, which may involve stretching, for example, relatively hard-to-reach vertebrae and/or loosening of tight and/or knotted muscles in various portions or regions of the body.

Certain physical and/or massage therapy devices include roller elements of various configurations, such as, for example, devices including one or more cylindrically-shaped, spherically-shaped and/or wheeled devices or components. Such therapy device may be configured to treat tight and/or irritated/inflamed muscles or body members. For example, physical therapy devices as disclosed herein may be usable for providing myofascial release (e.g., self-myofacial release), which may include soft tissue therapy for the treatment of skeletal muscle immobility and/or pain.

Certain physical therapy devices include a singular cylindrical member (e.g., foam roller), which may comprise foam or plastic and may present substantially cylindrical surfaces that may be smooth, ridged, compressible, grooved, knobby, or a combination thereof, for massaging or kneading relatively large areas of the body. Such devices may have various length and/or diameter dimensions. Physical therapy devices may additionally or alternatively include one or more spherical forms or members. For example, a physical therapy device may comprise one or more solid and/or hollow balls mounted or secured in some manner to a shaft member (e.g., axial shaft extending along a longitudinal axis of the device(s)). Such balls/knobs may be substantially spherical or elliptical. In certain embodiments, spherical/elliptical members (e.g., balls) associated with physical therapy devices may be disposed at a substantially fixed, non-adjustable width apart. Furthermore, spherical/elliptical members may have various diameter(s).

Although certain spherical-type therapy devices/rollers, as described above, may provide various benefits, some such devices may be shaped and/or configured to only broadly straddle the spine of a user, such that use of the device for back therapy may primarily provide massaging of the muscle, and may not provide sufficient manipulation of the spine. For example, certain physical therapy devices, such as foam or plastic/wood roller devices, may not provide the flexibility of shape and/or dimension to comfortably manipulate the region of the back positioned between the user's shoulder blades, or other relatively tight areas or regions of the body. Furthermore, cylindrical rollers may not provide massaging contact surfaces having varying depths/off-sets.

### Wheeled Therapy Device Structure

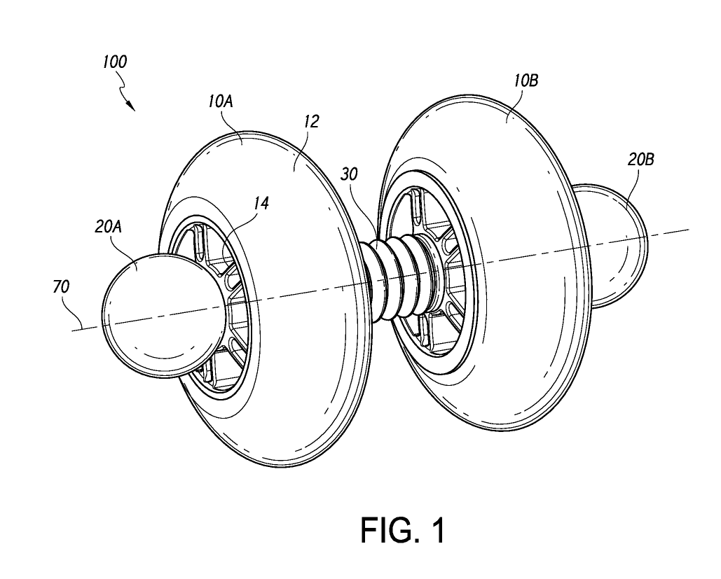

FIG. 1 is a perspective view of a physical therapy device according to one or more embodiments. The physical therapy device 100 includes a first wheeled massaging member 10A and a second wheeled massaging member 10B, which may be utilized by a user to massage body tissue/body part(s). The physical therapy device 100 may be utilized for spinal joint mobilization without substantial risk of injury to the user. Certain embodiments disclosed herein provide a device for muscle massage. For example, the device 100 may be useful for massage of one or more of the following muscles: gastrocnemius, latissimus dorsi, piriformis, adductors, quadriceps, hamstrings, hip flexors, thoracic spine (trapezius and rhomboids), lumbar spine, cervical spine, or other muscles or muscle groups. Such exercise massaging may be particularly useful for athletes, such as surfers, golfers, gymnasts, football players, baseball players, tennis players, and others, and may provide improved mobility and/or range of motion for such athletes and others.

The physical therapy device 100 may further include one or more additional components which may contribute to a massaging experience of the user. For example, the physical therapy device 100 may include one or more at least partially rounded end members/caps 20A, 20B. In certain embodiments, the one or more end members 20A, 20B may be at least partially spherical in shape. The one or more end members may be a unitary form together with an axle member or other component of the physical therapy device 100, or may be separate pieces or components. For example, the end members 20A, 20B may be detachable from, and/or rotatable or otherwise movable relative to, one or more other components of the device 100.

In certain embodiments, the one or more end members 20A, 20B may be shaped and/or configured to provide massaging functionality according to one or more use cases. For example, while the one or more wheel members 10A, 10B may have a greater radius than the one or more end members 20A, 20B, and therefore may be designed to provide deeper-tissue massage than the one or more end members 20A, 20B, the end members 20A, 20B, may be designed to have a diameter and/or other physical characteristics that allow for relatively shallower tissue massage relative to the one or more wheel numbers 10A, 10B. Additionally or alternatively, the reduced radius and/or size of the end members 20A, 20B relative to the wheel members 10A, 10B, may allow for massaging of tissue and/or body parts positioned/disposed at a physical offset with respect to tissue and/or body parts targeted for massage by the one or more wheel members 10A, 10B. The end members 20A, 20B may provide trigger-point therapy on, for example, rhomboids and infrapinatus and supraspinatus muscles in certain embodiments.

The physical therapy device 100 may further comprise a spring and/or tensioning/resistance member 30, which may be disposed at least partially between the first and second wheel members 10A, 10B. In certain embodiments, the physical therapy device 100 comprises an axle member (not shown) that each of the end members 20A, 20B, wheel members 10A, 10B, and/or resistance member 30 is disposed about. For example, the axis 70 illustrated in FIG. 1 may represent a longitudinal central axis of the axle member, or device 100. Certain embodiments do not comprise a separate axle member. For example, in certain embodiments, two or more of the end members 20A, 20B, wheel members 10A, 10B and/or resistance member 30 may comprise a unitary structure/form with each other and/or an axle structure of the device 100, wherein substantial rotation or movement of such members relative to the each other and/or the axle or axle structure is not possible or is restricted.

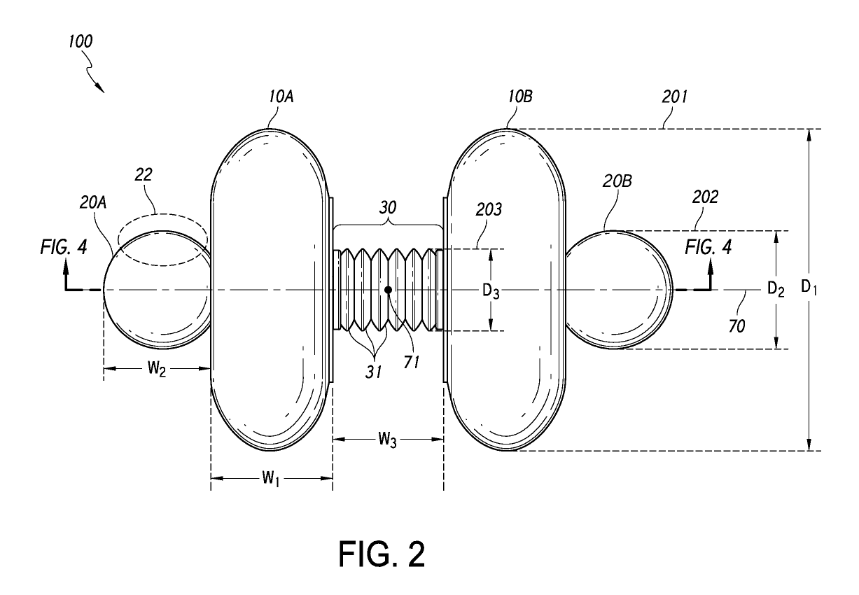

The resistance member 30 may be positioned between the first and second wheel members 10A, 10B, such as to provide outward force in an axial direction against inside surfaces of both the first wheel member 10A and the second wheel member 10B. Resistance from potential energy loading of the resistance member 30, provided by the resistance member 30 against the wheel members 10A, 10B, may improve massaging functionality and/or user experience by at least partially restricting the motion of the one or more wheel members 10A, 10B by pushing the one or more wheel members 10A, 10B against the one or more end members 20A, 20B, respectively. In certain embodiments, the resistance member 30 may be configured in such a way as to allow for contraction of the same. For example, in certain embodiments, one or more of the wheel members 10A, 10B may be movable to some degree in an axial direction towards an axial center (not identified in FIG. 1, see reference number 71 in FIG. 2) of the device 100.

In certain embodiments, the resistance member 30 may be designed to provide massaging functionality. For example, certain embodiments disclosed herein comprise a resistance member that has a bellows-type form, having one or more apexes or peaks 31 (see FIG. 2) that may be dimensioned and/or configured to provide massaging pressure at certain points along the axis 70 of the device 100 to skin and/or tissue coming in physical contact therewith. The bellows-type form may be desirable over a spring form in order to provide massaging functionality with reduced tendency to pinch skin, as may occur between spring wires when skin is disposed therebetween.

The resistance member 30 may comprise one or more relatively soft, but lancinating ridges 31, which may be designed and/or configured to stimulate blood flow in the dermis of the skin, which may aid in the healing process and/or provide one or more other benefits. The ridges/peaks 31 may provide a somewhat sharp skin-feel to the epidermis, thereby promoting the shedding of dead cells. The massaging effect of the resistance member 30 may help to eliminate cellular build-up and/or increase venous blood flow. For example, the resistance member 30 may serve to excite and/or tonify the muscles and nerves of the skin, thus promoting improved venous circulation and/or capillary circulation. The massaging effect of the resistance member 30 may further stimulate oxygenation of the dermis in certain embodiments.

When being used by a user, the wheel members 10A, 10B may make contact with user tissue and/or body part(s), for example to provide relatively deep-tissue massaging, while the resistance member 30 may provide relatively superficial massaging to tissue and/or body parts physically oriented between the massaged tissue contacting the wheel members 10A, 10B in the axial direction of the device 100. For example, the massaging resistance member 30 may provide a superficial skin massage to skin physically contacting the same. In certain embodiments, the massaging resistance member 30 may comprise a material that is relatively soft compared to material of one or more of the wheel members 10A, 10B and end members 20A, 20B. The softness/rigidity of the materials of the various components of the physical therapy device 100 may be designed to provide certain massaging effects associated with such materials. In certain embodiments, the end members 20A, 20B may comprise a material that is relatively harder/more-rigid, at least at a portion of the end member that provides a massaging surface, than corresponding surfaces/regions of other massaging components of the device 100, such as the wheels 10A, 10B and/or massaging resistance member 30. In certain embodiments, the wheels 10A, 10B comprise material, at least at a portion of the wheel that provides a physical massaging surface, that is less hard/rigid than that of the end members 20A, 20B, but harder/more rigid than that of the massaging resistance member 30.

Wheel members 10A, 10B, in certain embodiments, may comprise separate spoke portions 14 and body portions 12, as identified in FIG. 1. However, it should be understood that although certain wheel designs/configurations are illustrated in certain figures associated with the present disclosure, wheels or other massaging structures having any desirable shape and/or configuration, and/or any desirable structure, may be implemented within the scope of the present disclosure.

In certain embodiments, the physical therapy device 100 of FIG. 1 comprises a single axel supporting the one or more wheels 10A, 10B. In certain embodiments, a wheeled physical therapy device may comprise a plurality of axels, wherein each may have one or more wheels configured to rotate thereabout. Certain embodiments comprise one or more handles mounted at one or more ends of an axle, or shaft, of a wheeled physical therapy device, such that pressure may be applied by a user (e.g., physical therapist or masseuse) at the handle(s), the pressure being at least partially concentrated at a contact surface, or surfaces, of the one or more wheels. In certain embodiments, one or more handles may be mounted on one or both ends of the axle member. In certain embodiments, a single handle may be mounted substantially in-line with a longitudinal axis of the device, such that pressure may be applied by a user (e.g., physical therapist or masseuse) using the handle. However, handled embodiments may be undesirable as not providing the secondary massaging functionality of the end members 20A, 20B disclosed herein. Wheels in a wheeled physical therapy device may be disposed at a substantially fixed, non-adjustable width apart. Furthermore, wheels in a physical therapy device may have various diameter and/or thickness dimensions.

In comparison to certain foam-roller physical therapy devices, the physical therapy device 100 of FIG. 1 may provide a relatively more rugged, use-specific design, which may provide improved mobility for a user in a reduced amount of time. For example, the physical therapy device 100 may provide a relatively deep tissue massaging in one or more selected areas of the body without providing substantial massaging of surrounding tissue. Furthermore, certain embodiments are configured to allow for self-spinal manipulation without substantial risk of injury or damage to the spine and/or surrounding tissue.

With further reference to FIG. 1, the illustrated device 100 may provide a wheeled roller system capable of self-mobilization of soft tissues, such as of the back, hips and/or legs. Therapy systems and methods disclosed herein may allow for relaxation of contracted muscles, improvement of blood and/or lymphatic circulation, and/or stimulation of the stretch reflex in certain muscles or muscle groups. Certain embodiments may allow for improvement of soft tissue extensibility through myofascial release, thus relaxing the target muscle(s) and/or allowing the activation of the antagonist muscle(s). The position and/or configuration of the wheel members 10A, 10B, the end members 20A, 20B, and/or massaging resistance member 30 may allow for the delivery of relatively precise, focused pressure in desired regions, such as in one or more regions of a user's thoracic spine, glutes, hips, thighs, calves, feet, and/or others. Furthermore, with respect to adjustable embodiments, such adjustability may allow for modification and customization of the focused pressure. The massaging functionality of the physical therapy device 100 may help resolve or reduce the occurrences of locked-up joints and/or stiff muscles, which can reduce range of motion and/or subject back, joints or other body parts to additional strain or injury. The various components of the physical therapy device 100 may allow for stimulation of muscles or other body parts that may be difficult or impossible to reach with a standard foam roller device.

FIG. 2 represents a front, back, top and/or bottom view of the physical therapy device of FIG. 1 according to one or more embodiments. As shown in FIG. 2, the wheel members 10A, 10B of the physical therapy device 100 may have a width W₁, which may be designed to provide desirable massaging functionality/characteristics. For example, where it is desirable for massaging pressure to be distributed over a relatively wide surface area, it may be desirable for the wheel members 10A, 10B to have relatively wide dimensions. In addition, FIG. 2 illustrates a diameter dimension D₁ of the wheel members 10A, 10B, which may be any desirable value. In certain embodiments, the diameter D₁ of the wheel members 10A, 10B may affect a depth of massaging.

As described above, the end members 20A, 20B may also be configured to provide massaging functionality. Therefore, similarly to the wheel members 10A, 10B, a width W₂ of the end members 20A, 20B may be designed to provide desirable massaging characteristics. In certain embodiments, the end members 20A, 20B are generally spherical in shape, at least with respect to a massaging contact portion 22 of an end member, which may provide desirable distribution of pressure for targeting a target muscle, tissue, or area the user. Although a substantially-spherical end member 20A is illustrated in FIG. 2, it should be understood that other shapes may also be desirable to provide certain massaging characteristics. For example, end members having elliptical, flat and/or pointed massaging contact surfaces may be desirable in certain embodiments. In certain non-spherical embodiments, the end members 20A, 20B may have a diameter dimension D₂ that is different from a width dimension W₂.

The massaging resistance member 30 may likewise be dimensions to provide desirable resistance and/or massaging functionality. In certain embodiments, the massaging resistance member 30 may be configured to contract and/or expand based at least in part on an amount of axial space available for the resistance member 30 to occupy between the wheel members 10A, 10B. The relative diameters of the various components, such as the end members 20A, 20B, wheel members 10A, 10B, and massaging resistance member 30 (which may have a diameter dimension D₃), may at least partially dictate relative massaging off-sets of the various components. For example, where the massaging resistance member 30 has a diameter that is relatively large, the massaging effect of such member may be effected more easily and/or consistently, due to the reduced radial offset between the massaging contact surface plane 203 of the resistance member 30 and the massaging contact surface plane 201 of the wheel members 10A, 10B. In addition, the various peaks, or teeth, 31 of the massaging resistance member 30 may have a desirable depth to provide a desired massaging functionality and/or compression/resistance behavior. Although the massaging resistance member 30 may be described herein as a single form or component, in certain embodiments, the massaging resistance member 30 comprises a plurality of separate forms or components.

In certain embodiments, the dimensions and/or configuration of the wheel members 10A, 10B may be designed and/or adjusted to fit between a user's shoulder blades, such that force may be applied through the wheels directly to spinal joints and/or muscles. Although certain configurations of the physical therapy device 100 may be particularly suited for mobilization of the thoracic spine, other muscles, joints, and/or body parts may be treated using various configurations and methods, as disclosed herein.

The illustrated planes 201, 202, 203 illustrate the variable massaging depths presented by the physical therapy device 100 in association with the wheel members 10A, 10B, end members 20A, 20B, and massaging resistance member 30, respectively. The different massaging depths may allow for the device 100 to penetrate and reach areas/joints/muscles that a foam roller, or other devices, may not be able to access sufficiently. The massaging planes 201, 202 and/or 203 may provide staggered/offset massaging depths, which may be desirable for certain therapy purposes.

Muscles and joints can become stiff or sore from various physical activities, such as sitting at a desk, exercising, or otherwise straining the muscles or joints. The physical therapy devices disclosed herein may provide relief from such conditions and/or restore or improve mobility in a relatively short period of time.

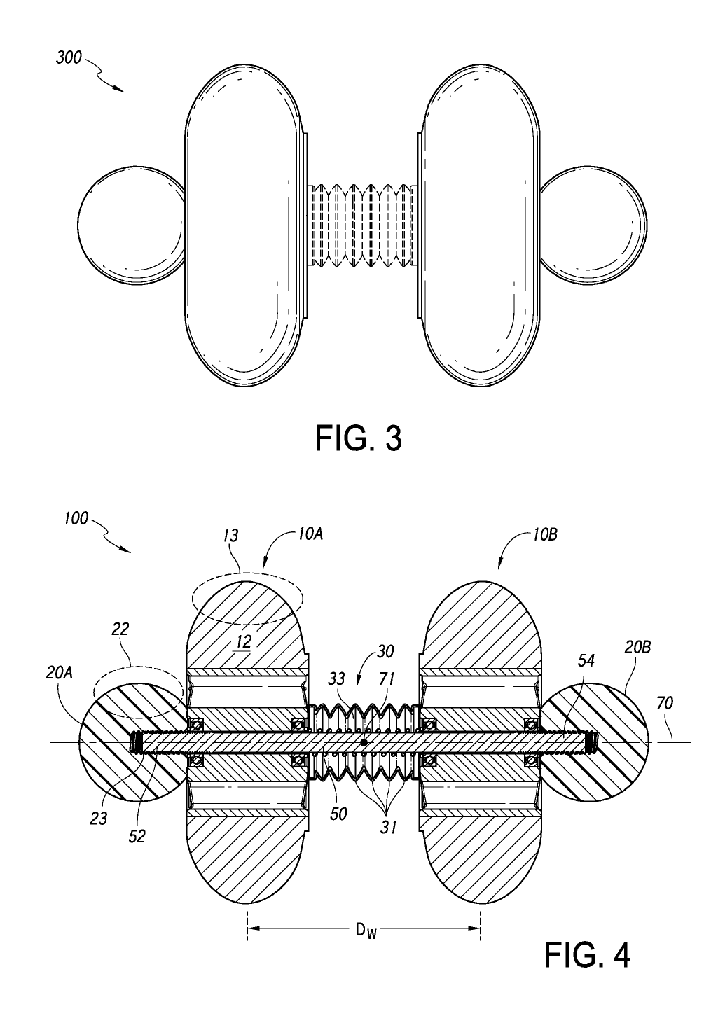

FIG. 3 represents a front, back, top and/or bottom view of the physical therapy device of FIG. 1 according to one or more embodiments. FIG. 3 shows certain design features and/or characteristics of a physical therapy device 300 according to certain embodiments. Although certain design features are illustrated in FIG. 3, and throughout the present disclosure, it should be understood that physical therapy devices and/or components thereof disclosed herein may comprise features having any desirable and/or practical design and/or configuration within the scope of the present disclosure.

FIG. 4 represents a cross-sectional front, back, top and/or bottom view of an embodiment of the physical therapy device of FIG. 1. FIG. 4 shows an embodiment in which one or more of end members 20A, 20B may be dimensioned and/or configured to engage with an axle member 50. For example, the axle member 50 (not present in certain embodiments) of the physical therapy device 100 may comprise one or more male threaded distal end portions 52, 54, configured to engage with corresponding female engagement recesses of the end members 20A, 20B. For example, one or more of the end members 20A, 20B, may include a female threaded recess 23, wherein rotation, such as clockwise rotation, of the end member relative to the axle member 50, where the end member is engagingly disposed at least partially over the threaded end portion 52 of the axle 50, may secure and/or further dispose the end member over the axle member.

Tightening rotation of one or more of the end members 20A, 20B relative to the axle member 50 may introduce inward axial force against one or more of the wheel members 10A, 10B in a direction towards an axial center 71 of the physical therapy device 100. For example, as one or more of the end members 20A, 20B, move axially inward, an inner surface of the respective end member may exert force against an outer surface of a wheel member, thereby displacing the wheel member in a direction axially inward. Such adjustability of relative wheel position in the physical therapy device 100 may provide flexibility in configuring the structure of the physical therapy apparatus 100 for a particular user or purpose. Therefore, a wheel-to-wheel distance D_{W} may be at least partially controllable/configurable, thereby providing customizable/configurable massaging functionality for the device 100.

As shown in the diagram in FIG. 4, the physical therapy device 100 may include a bellows form 30, which may provide the functionality of the above-described massaging resistance member 30. The bellows form 30 may include a plurality of peak/apex portions 31 as well as an interior air cavity region 33. In certain embodiments, one or more air gaps and/or apertures may be provided, such as at an interface between the resistance member 30 and one or more of the wheel members 10A, 10B, to allow air to escape when the bellows 30 is contracted and enter when the bellows 30 is expanded.

The cross-sectional shape of the wheel members 10A, 10B and/or end members 20 to a 20B may be substantially convex, and may have any desirable pitch and/or shape.

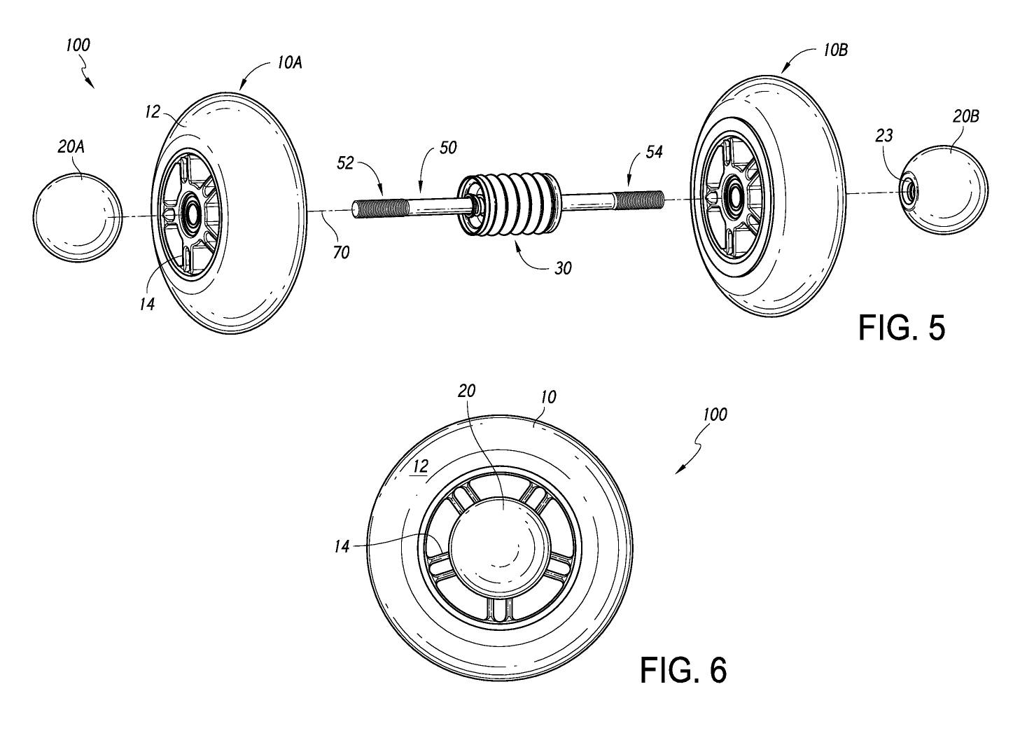

FIG. 5 illustrates an exploded view of the physical therapy device 100 shown in FIG. 1. With reference to FIG. 5, and with further reference to FIG. 1, the illustrated device 100 may comprise first and second wheel members (10A, 10B) disposed about a longitudinal shaft, or axle member 50, wherein the wheels 10A, 10B are configured to rotate about the axle member 50. The device 100 may further comprise a resistance member 30 disposed about the axle 50 between the first and second wheel members 10A, 10B. The device 100 may further comprise a plurality of threaded axle portions 52, 54 at distal ends of the axle member 50. Adjustable knob and/or end cap members 20A, 20B may be utilized to mate with one or more of the distal end portions 52, 54 of the axle member 50, wherein interior threaded cavities of one or more of the end cap members 20A, 20B are configured to mate with the threaded features of the distal end portions 52, 54, respectively, of the axle member 50. Therefore, the end/knob members 20A, 20B may be rotatably tightened or fitted to the distal end portions 52, 54. The end cap member(s) (20A and/or 20B), as they encroach in an inward direction, such as by rotation of the end cap member(s) in a clockwise direction, may be configured to push or force the respective wheel members 10A, 10B inward towards one another. In certain embodiments, the device 100 includes one or more washers (not shown) or other components disposed between the knob or cap members 20A, 20B.

The resistance member 30 may be configured to provide outward resistance against the one or more wheels of the device, such that when the wheels are pushed inward, the spring member provides outward pressure to thereby retain desired spacing between the wheels. Therefore, certain embodiments provide a wheeled physical therapy device that allows for modification of relative positions of wheels disposed about a shaft member. Such adjustability may advantageously allow for customization of the device to improve the effect and/or results of use of the device for physical and/or massage therapy by a user.

FIG. 6 is a side view of the physical therapy device of FIG. 1 according to one or more embodiments. The view of FIG. 6 shows a wheel member 10 having a spoke portion 14 and a body portion 12. FIG. 6 further illustrates an end member 20, such as a spherical end member.

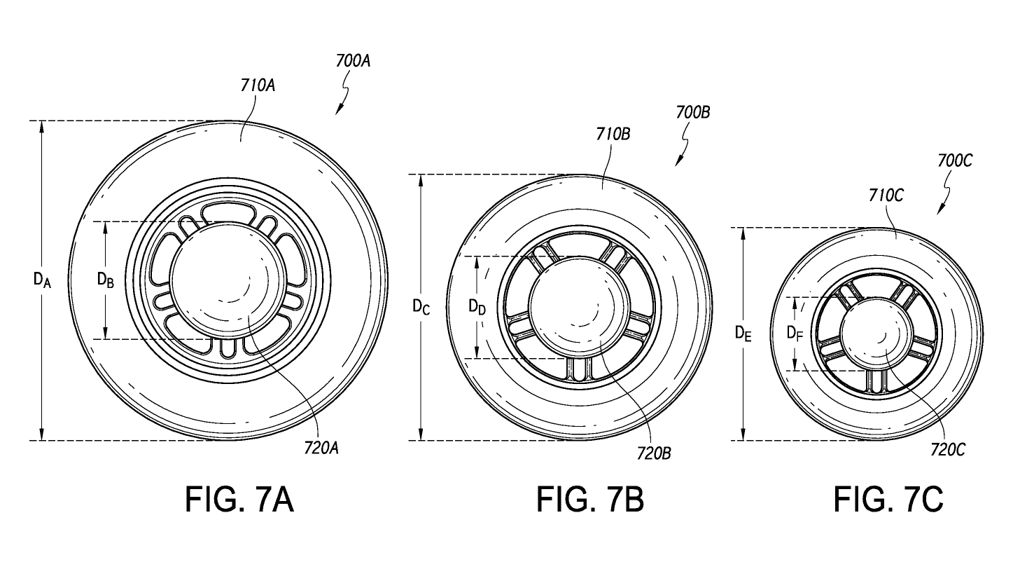

FIGS. 7A-7C are side views of physical therapy devices according to various embodiments. The various embodiments depicted in FIGS. 7A-7C illustrate various wheel and end cap dimensions that may be implemented in accordance with the present disclosure. Although certain actual and/or relative dimensions are provided herein, it should be understood that any desirable or suitable dimensions may be implemented within the scope of the present disclosure. A first device embodiment 700A may have a wheel diameter D_{A} of approximately 100 mm, an end cap diameter D_{B} of approximately 28 mm, and a resistance member diameter of approximately 22 mm; a second device embodiment 700B may have a wheel diameter D_{C} of approximately 80 mm, an end cap diameter D_{E} of approximately 25 mm, and a resistance member diameter of approximately 22 mm; a third device embodiment 700C may have a wheel diameter D_{E} of approximately 60 mm, an end cap diameter D_{F} of approximately 25 mm, and a resistance member diameter of approximately 22 mm.

Certain embodiments have wheel dimensions and/or other dimensions that advantageously provide device portability, which may allow for relatively easy transport of the device, which may be desirable for a variety of reasons. Relatively small-scale embodiments may also allow for device utilization in relatively small spaces. Furthermore, the various different sizes/dimensions possible, as well as the potential adjustability of devices disclosed herein may be desirable to account for the varying skeletal and/or muscle structure of different potential users. Furthermore, the flexibility in size and adjustability may be beneficial for treating different areas of the spine and/or other parts of a single user's body, and may provide different application possibilities with respect to desired degree of stretching.

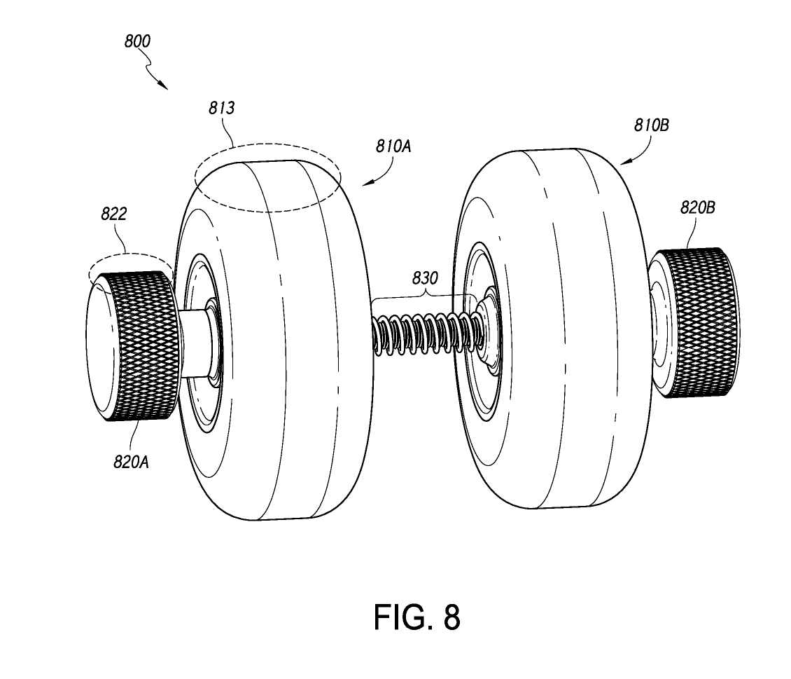

FIG. 8 represents a perspective view of a physical therapy device 800 showing a side view and a front, back, top and/or bottom view of the physical therapy device 800 according to one or more embodiments. The device 800 comprises end cap members 820A, 820B having an alternative shape or configuration relative to those illustrated in FIG. 1 and described above. For example, one or more of the end cap members 820A, 820B may have a substantially flat massaging contact surface (e.g., surface 822), and may further have a patterned massaging surface feature, as shown. In addition, the embodiment of FIG. 8 may comprise wheel members 810A, 810B having at least partially flat massaging contact surfaces (e.g, surface 813). The physical therapy device 800 may further comprise a spring-type resistance member 830. Although certain shapes and configurations of wheels, springs and/or end cap members are shown and disclosed herein, one having ordinary skill in the art will appreciate that any desirable and/or practical shape or configuration of such features may be utilized within the scope of the present disclosure.

### Methods of Use of Physical Therapy Device

Certain embodiments of physical therapy devices as disclosed herein may be used for joint mobilization, soft tissue mobilization, and/or massage, which may be accomplished using various methods described herein. For example, in an embodiment, a user may place the wheeled device in one of a variety of possible locations on the body, wherein by primarily applying the user's own bodyweight, the user may target a specific vertebra or group of vertebrae, or other soft tissue or muscle(s) for manipulation and/or massaging.

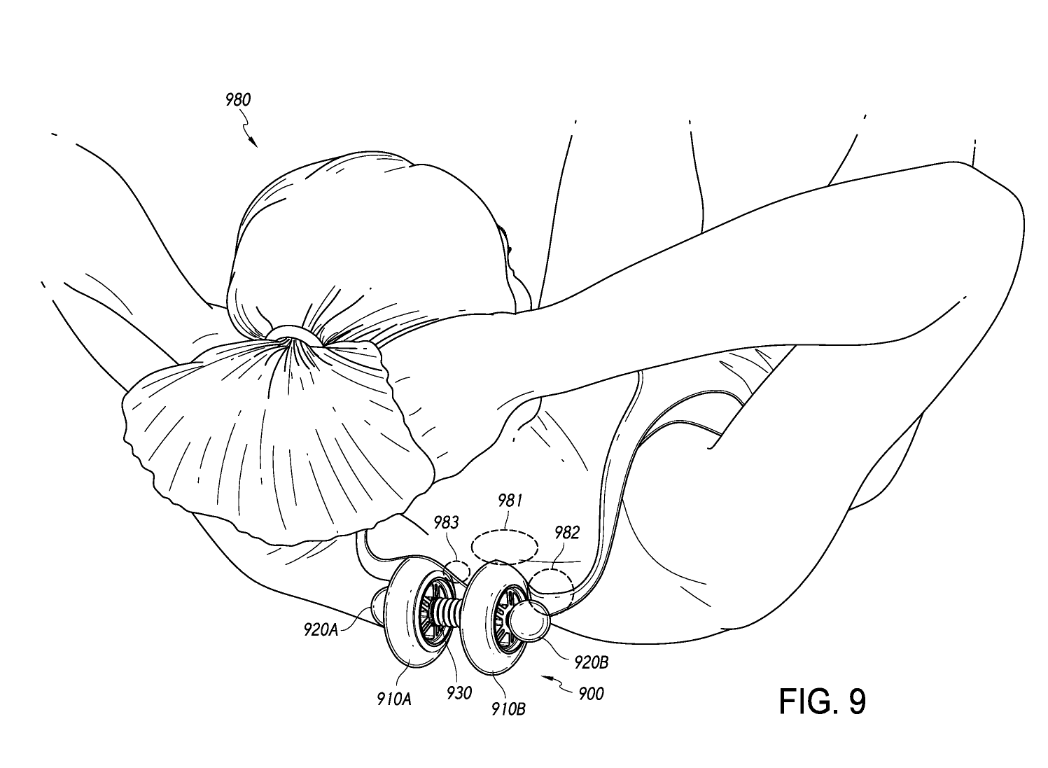

FIG. 9 illustrates a user using a physical therapy device 900 according to one or more embodiments. As an example, by placing the physical therapy device 900 on a floor or other surface, with the axel of the device substantially perpendicular to the spine (or other target region) and at least partially straddling the spine itself, self-spinal manipulation may be accomplished as the user 980 slowly and gently rolls his or her body along the device 900. Additionally or alternatively, the user 980 may roll the device 900 along a length of the spine, and may advantageously target a specific portion or region of the spine by letting the device 900 rest at a specific area.

The physical therapy device 900 may have primary wheel massagers 910A, 910B, which may advantageously provide relatively deep massaging of target tissue/muscle(s) 981. The physical therapy device 900 may further include one or more secondary, relatively recessed, massaging members, such as end cap members 920A, 920B, which may provide a massaging effect for tissue/muscles in a separate area 982 of the body adjacent to the target area 981. The secondary massaging members 920A, 920B may not provide as deep a massaging effect as the primary massagers 910A, 910B in certain embodiments. The physical therapy device 900 may further include an additional central massaging member 930, which may be configured to provide a relatively shallow/superficial massaging effect with respect to a central body area 983 adjacent to the primary target area 981.

The physical therapy device 900 may advantageously be utilized against a surface that provides adequate resistance, such as a carpet surface, yoga mat, or the like. The wheels 910A, 910B may be rolled, or remain substantially stationary (i.e., not rotating about an axis of the device), depending on the application.

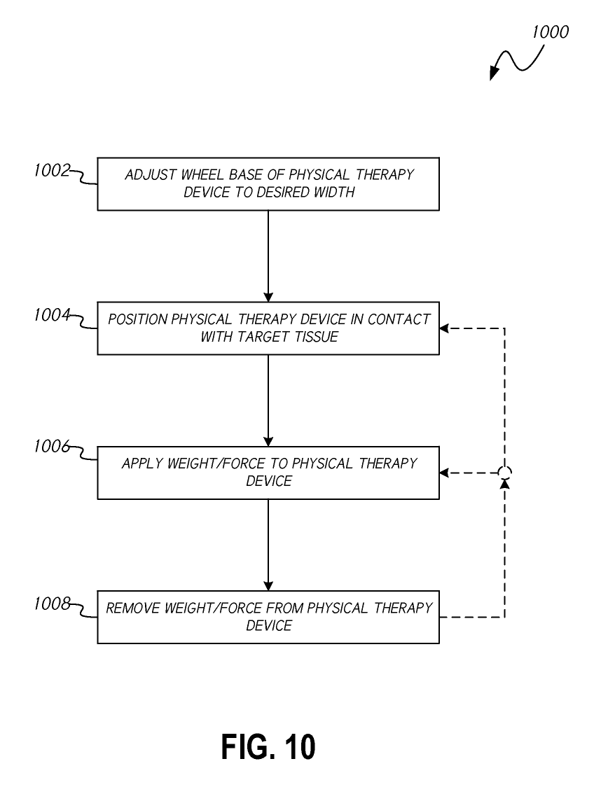

FIG. 10 is a flow diagram illustrating a process 1000 for utilizing a physical therapy device according to one or more embodiments disclosed herein. At block 1002, the process 1000 involves adjusting a width of a wheel base of a physical therapy device, which may have one or more features disclosed herein. For example, a narrower wheel base may be used to target a relatively small, focused area, whereas a relatively wide wheel base may be used to isolate separate muscles.

For back therapy, the width of the wheel base may be set relatively narrow to provide joint mobilization, whereas a relatively wider wheel base may be used to mobilize the paraspinal muscles. For foot therapy, a relatively narrow wheel base may be used to mobilize the plantar muscles, tendons and/or ligaments of the foot.

At block 1004, the process 1000 involves positioning the physical therapy device to contact the targeted tissue or body part. For example, with the user's weight at least partially supported (e.g., by the elbows for back therapy), the user may roll the physical therapy device under the body to contact a target region that is undesirably stiff or immobile. For example, the physical therapy device may be positioned to target the thoracic spine according to one implementation. The thoracic spine, which may generally occupy space between a user's shoulder blades, may ideally have the ability to rotate, extend, and flex in a substantially fluid manner. However, where immobility and/or stiffness in the thoracic spine is present, such immobility/stiffness can result in a reduction of range of motion and/or an increase in torque and/or strain experienced by the lower back and/or other joints, and can result in injury. The process 1000 may advantageously allow for the isolation of vertebral joints, such they can be individually manipulated and/or adjusted by a user without direct assistance from another person, such as a chiropractor, doctor, or physical therapist. Back therapy using the physical therapy device may target one or more vertebrae, such as in the thoracic region, as well as the para vertebral muscles along the spine. In certain embodiments, the process 1000 may substantially improve thoracic mobility.

For hamstring therapy, the physical therapy device may be positioned to isolate any of the muscles of the hamstring, such as the semitendinosus, semimembranosus, biceps femoris, or biceps femoris. In certain embodiments, a user may sit on the floor or other surface and position the physical therapy device under the hamstring, and further treat the hamstring muscle(s) by lifting and lowering the leg to decrease and increase the load.

At block 1006, the process 1000 involves applying weight/force to the physical therapy device. The user may advantageously intake a large breath and exhale while lowering his or her body, or target body part, onto the physical therapy device. Application of weight/force according to the process 1100 may allow for relatively deep penetration of muscle tissue, which may desirably serve to expel lactic acid and/or improve blood circulation. Furthermore, a massaging resistance member disposed between the two wheels of the physical therapy device, as described above (e.g., bellows-shaped form), may provide effleurage of the skin positioned between the two wheels. Round end cap members of the physical therapy device may further provide massaging of tissue outside of one or more of the wheels.

With respect to back therapy, the user may lower himself or herself down onto the physical therapy device while using his or her arms as weight support. In certain embodiments, where relatively aggressive thoracic mobilization is desired, the user may rotate his or her shoulders in a side-to-side manner on top of the physical therapy device, for example with his or her hands positioned behind the head. Implementation of the process 1000 for back therapy may provide relief, for example, in the L4-L5 region of the lower back, and may reduce pain originating from the sacroiliac joint. Furthermore, by positioning the therapy device to target, for example, the third and/or fourth thoracic vertebra, the process 1000 may relieve upper thoracic tension and/or subluxations, which may be generally associated with forward-head carriage positions associated with computer use and driving, for example. Furthermore, implementation of the process may result in improved breathing, posture and/or back alignment.

With respect to shoulder therapy, the process 1000 may allow for mobilization of one or more muscles in the shoulder girdle (e.g., scapula, clavicle, and/or rhomboids) and/or shoulder joint (e.g., scapula and/or humerus). For example, the process 1000 may involve lying on the ground or other surface and lifting the shoulder up and setting it onto the device to generate desirable movement.

With respect to foot therapy, the process 1000 may involve the user setting his or her foot on top of the device and loading and unloading the user's weight on and off the physical therapy device to provide a desired massaging effect. With respect to calf and/or shin therapy, the process 1000 may allow for at least partial isolation of the gastrocnemius, soleus, tibialis anterior and/or fibula muscles. For example, the user may assume a sitting or kneeling position and set the calf or shin onto the physical therapy device. By loading and unloading his or her weight onto and off of the physical therapy device, the user may achieve substantial modification to tight and/or sore calf/shin muscles.

At block 1008, the process 1000 involves removing weight/force from physical therapy device, and possibly repeating one or more steps of the process, as indicated by the dashed lines in FIG. 10. For example, with respect to back therapy, the process 1000 may involve the user lifting his or her body off of the physical therapy device, rolling the device to a next joint, and repeating the massaging action. The process 1000 may allow the user to achieve a substantial depth and/or mobilization in a relatively short period of time compared to certain foam rollers, electrical stimulation devices, cold laser devices, ultrasound devices, and/or other physical therapy devices that may not be configured to isolate muscles/joints individually.

Although certain particular exercises are described above, it should be understood that massaging/exercise processes disclosed herein may be applicable for treatment of other areas of the body. For example, the physical therapy devices disclosed herein may be applied to other areas of the body as needed, wherein, as described above, the user may likewise use his or her own bodyweight, or other application of force, to control the amount of pressure applied to individual areas. For example, physical therapy devices having wheel configurations as described herein may be functional to substantially or sufficiently isolate and/or separates muscle tissues in the back, legs, chest, shoulders, and other areas of the body.

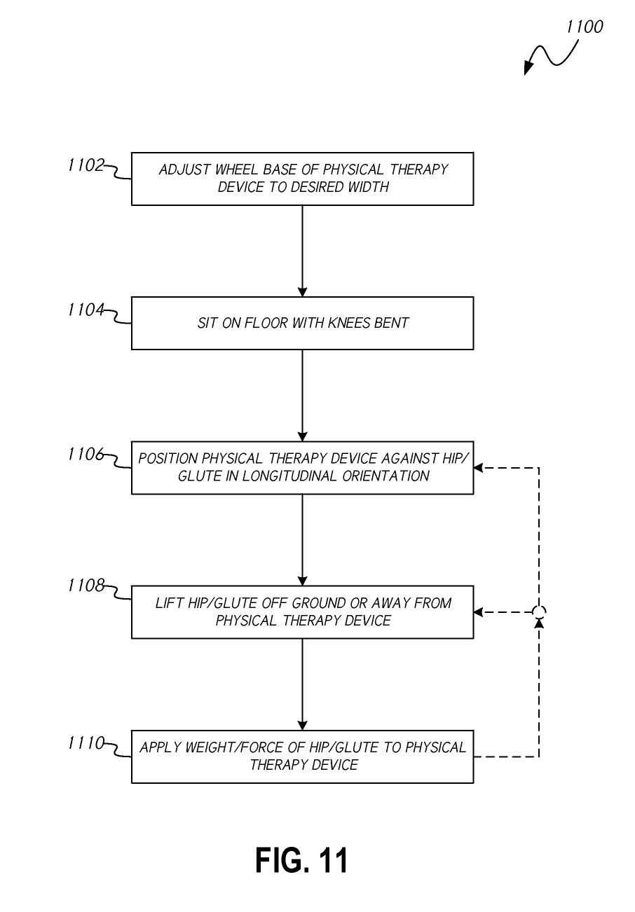

FIG. 11 is a flow diagram illustrating a process for using a physical therapy device according to one or more embodiments. The process 1100 may be implemented to treat target muscles(s)/joint(s) associated with the glute and/or hip of a user. For example, the process 1100 may be implemented to isolate the gluteus maximus, gluteus medius, and/or gluteus minimus muscles, which may help to mobilize the hip girdle, or other muscle(s)/joint(s).

At block 1102, the process 1100 involves adjusting a wheel base of a physical therapy device according to one or more embodiments disclosed herein to a desired width, which may depend on the particular muscle(s)/joint(s) it is desired to isolate. In certain embodiments, desirable results may be achieved when a user sets the device to a wheel base width that produces a degree of discomfort, indicating a position that may result in effective massaging.

At block 1104, the process 1100 involves assuming a sitting position on the floor or other surface, preferably with knees at least partially bent. At block 1106, the process 1100 involves positioning the physical therapy device against a hip or glute bone, joint, and/or muscle in a longitudinal orientation. For example, the user may sit with his or her knees bent, with the physical therapy device disposed transversally next to the hip.

At block 1108, the process 1100 involves lifting the hip or glute off the ground and/or off/away from the physical therapy device, and further applying body weight associated with the hip or glute back onto the physical therapy device. The process 1100 may provide substantial depth and/or isolation of hip and/or gluteal muscles. With respect to hip therapy, the process 1100 may provide the ability to mobilize the Iliopsoas and the Iliacus muscles as well as the hip girdle. In certain embodiments, a user may roll his or her body on the physical therapy device to mobilize the hip and gluteal muscle(s) at the same time, or as part of the same process. For example, the user may roll up and on top of the device similar to the gluteal process described above, and further roll onto the user's side with the physical therapy device disposed on the hip.

The processes 1000, 1100 disclosed may provide for reduced strain on connecting joints and promote healthy joint movement. Furthermore, the disclosed processes may provide for increased range of motion, injury prevention, and/or increased blood flow to muscles and/or joints.

### ADDITIONAL EMBODIMENTS

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” The word “coupled”, as generally used herein, refers to two or more elements that may be either directly connected, or connected by way of one or more intermediate elements. Additionally, the words “herein,” “above,” “below,” and words of similar import, when used in this application, shall refer to this application as a whole and not to any particular portions of this application. Where the context permits, words in the above Description using the singular or plural number may also include the plural or singular number respectively. The word “or” in reference to a list of two or more items, that word covers all of the following interpretations of the word: any of the items in the list, all of the items in the list, and any combination of the items in the list.

The above detailed description of embodiments of the invention is not intended to be exhaustive or to limit the invention to the precise form disclosed above. While specific embodiments of, and examples for, the invention are described above for illustrative purposes, various equivalent modifications are possible within the scope of the invention, as those skilled in the relevant art will recognize. For example, while processes or blocks are presented in a given order, alternative embodiments may perform routines having steps, or employ systems having blocks, in a different order, and some processes or blocks may be deleted, moved, added, subdivided, combined, and/or modified. Each of these processes or blocks may be implemented in a variety of different ways. Also, while processes or blocks are at times shown as being performed in series, these processes or blocks may instead be performed in parallel, or may be performed at different times.

Similarly, it should be appreciated that in the above description of embodiments, various features are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that any claim require more features than are expressly recited in that claim. Rather, inventive aspects lie in a combination of fewer than all features of any single foregoing disclosed embodiment.

The teachings of the invention provided herein can be applied to other systems, not necessarily the system described above. The elements and acts of the various embodiments described above can be combined to provide further embodiments.

While some embodiments of the inventions have been described, these embodiments have been presented by way of example only, and are not intended to limit the scope of the disclosure. Indeed, the novel methods and systems described herein may be embodied in a variety of other forms; furthermore, various omissions, substitutions and changes in the form of the methods and systems described herein may be made without departing from the spirit of the disclosure. The accompanying claims and their equivalents are intended to cover such forms or modifications as would fall within the scope and spirit of the disclosure.

What is claimed is:

1. A physical therapy device comprising:
a first rounded massaging form of a first diameter disposed at a first distal end of the physical therapy device;
a second rounded massaging form of the first diameter disposed at a second distal end of the physical therapy device;
a first wheel massager of a second diameter disposed adjacent to the first rounded massaging form between the first and second rounded massaging forms with respect to a longitudinal axis of the physical therapy device, the second diameter being greater than the first diameter;
a second wheel massager disposed adjacent to the second rounded massaging form between the second rounded massaging form and the first wheel massager with respect to the longitudinal axis; and
a central skin-massaging form having a third diameter disposed between the first wheel massager and the second wheel massager with respect to the longitudinal axis, the third diameter being smaller than the second diameter;
wherein the first and second rounded massaging forms, the first and second wheel massagers, and the central rounded massager are coaxial about the longitudinal axis.

2. The physical therapy device of claim 1, wherein rotation of at least one of the first and second rounded massaging forms reduces an axial distance between the first and second wheel massagers.

3. The physical therapy device of claim 1, wherein the third diameter is smaller than the first diameter.

4. The physical therapy device of claim 1, wherein a massaging surface of the first and second wheel massagers comprises a first material, a massaging surface of the first and second rounded massing forms comprises a second material, and a massaging surface of the central skin-massaging form comprises a third material, wherein the first material is less rigid than the second material and more rigid than the third material.

5. The physical therapy device of claim 1, wherein the first and second rounded massaging forms are at least partially spherical in shape.

6. The physical therapy device of claim 1, wherein the first rounded massaging form is configured such that rotation of the first rounded massaging form relative to the second rounded massaging form causes the first and second wheel massagers to be brought closer together.

7. A physical therapy device comprising:
an axle member having first and second distal ends;
a first wheel of a first diameter disposed about the axle member;
a second wheel of the first diameter disposed about the axle member;
a first rounded end cap massager disposed at least partially over the first distal end of the axle member, the first rounded end cap massager having a second diameter that is less than the first diameter; and
a second rounded end cap massager disposed at least partially over the second distal end of the axle member.

8. The physical therapy device of claim 7, wherein rotation of at least one of the first and second rounded end cap massagers reduces an axial distance between the first and second wheels.

9. The physical therapy device of claim 8, wherein the axle member comprises a male threaded distal end and the first rounded end cap comprises a female threaded recess configured to receive the threaded distal end of the axle member.

10. The physical therapy device of claim 7, further comprising a resistance member disposed about the axle member between the first and second wheels and configured to provide outward force against the first and second wheels in an axial direction.

11. The physical therapy device of claim 10, wherein the resistance member is a one-piece bellows form configured to provide relatively superficial skin massage functionality.

12. The physical therapy device of claim 7, wherein a massaging surface of the first and second wheels comprises a first material and a massaging surface of the first and second rounded end cap massagers comprise a second material, wherein the second material is more rigid than the first material.

13. The physical therapy device of claim 7, wherein the first and second rounded end cap massagers are at least partially spherical in shape.

14. The physical therapy device of claim 7, wherein the first and second wheels have at least partially flat massaging contact surfaces.

15. The physical therapy device of claim 7, wherein a massaging contact surface of each of the first and second wheels includes an axial apex portion.

16. A method of massaging tissue, the method comprising:
providing a physical therapy device comprising:
an axle member having first and second distal ends;
a first wheel of a first diameter disposed about the axle member;
a second wheel of the first diameter disposed about the axle member;
a first rounded end cap massager disposed at least partially over the first distal end of the axle member, the first rounded end cap massager having a second diameter that is less than the first diameter; and
a second rounded end cap massager disposed at least partially over the second distal end of the axle member;
adjusting an axial distance between the first and second wheels to a desired distance;
positioning the physical therapy device in contact with a target body area;
applying body weight against the physical therapy device at the target body area; and
removing body weight from the physical therapy device.

17. The method of claim 16, further comprising rotating at least one of the first and second rounded end cap massagers to reduce an axial distance between the first and second wheels.

18. The method of claim 17, wherein the axle member comprises a male threaded distal end and the first rounded end cap comprises a female threaded recess configured to receive the threaded distal end of the axle member.

19. The method of claim 16, wherein the physical therapy device further comprises a resistance member disposed about the axle member between the first and second wheels and configured to provide outward force against the first and second wheels in an axial direction.

20. The method of claim 19, wherein the resistance member is a one-piece bellows form, the method further comprising massaging target skin using the resistance member.
